(19) United States
(12) Patent Application Publication
(10) Pub. No.: US 2013/0300311 A1
(43) Pub. Date: Nov. 14, 2013

(54) LIGHT EMITTING DIODE LIGHTING DEVICE WITH DUTY CYCLE CAPABLE OF BEING TUNED

(71) Applicants: KUAN-HONG HSIEH, Chu-Nan (TW); Te-Sheng Chen, Chu-Nan (TW); Hsien-Chung Shih, Chu-Nan (TW); Ji-Bao Fu, Shenzhen City (CN)

(72) Inventors: KUAN-HONG HSIEH, Chu-Nan (TW); Te-Sheng Chen, Chu-Nan (TW); Hsien-Chung Shih, Chu-Nan (TW); Ji-Bao Fu, Shenzhen City (CN)

(73) Assignee: FOXSEMICON INTEGRATED TECHNOLOGY, INC., Chu-Nan (TW)

(21) Appl. No.: 13/610,997

(22) Filed: Sep. 12, 2012

(30) Foreign Application Priority Data
May 14, 2012 (CN) 201210147347.X

(51) Int. Cl. H05B 37/00

(52) U.S. Cl. 315/246

(57) ABSTRACT

An LED lighting device is provided. The LED lighting device includes a processing unit, a sensor, a MOSFET, and an LED. When the sensor detects a frequency or voltage fluctuation, the processing unit modulates the duty cycle of the MOSFET to reduce the energy consumption of the LED light device and improve the efficiency of luminance of the LED lighting device.

### BACKGROUND

1. Technical Field

The disclosure is related to a light emitting diode (LED) lighting device, and particularly to an LED lighting device with at duty cycle capable of being tuned, to save energy under circumstances of input voltage fluctuation and input frequency fluctuation.

2. Description of Related Art

Efficient lighting options are replacing old fashioned energy-hungry incandescent light bulbs and halogen spotlights. One of the major options is the LED. To obtain an adjustable brightness, dimmers for the LEDs are required to provide currents in a range for driving LEDs. A superior method of dimming LEDs is to use pulse width modulation (PWM). As is well known, the PWM process is a convenient way to interface a duty cycle controller with a switching converter.

With PWM, strings of LED bulbs can all be driven with the recommended forward current, with the dimming achieved by turning the LEDs on and off at high frequency, so fast the human eye cannot see the strobing effect. The longer the on periods, the brighter the LEDs will appear to the observer.

However, input voltage of the LED bulbs is rarely constant. It may be affected by the power system or ambient electrical environment. To obtain a truly constant current, amounts of energy are consumed to overcome potential differences, resulting from voltage fluctuation or frequency fluctuation. Improvements in reducing the energy consumption of the LED bulbs caused by voltage fluctuations or frequency fluctuations are desirable.

### BRIEF DESCRIPTION OF THE DRAWINGS

The components in the drawings are not necessarily drawn to scale, the emphasis instead being placed upon clearly illustrating the principles of an LED lighting device With a duty cycle capable of being tuned. Moreover, in the drawings, like reference numerals designate corresponding parts throughout the several views.

FIG. 1 is a circuit diagram of an LED lighting device 10 of the disclosure.

FIG. 2 shows a waveform of an input voltage of the LED lighting device 10, which has a metal-oxide-semiconductor field-effect transistor (MOSFET) 16 maintaining in the saturation mode. The dotted line represents the current flow through an LED 18 of the LED lighting device 10.

FIG. 3 shows a waveform of the LED light device 10 experiencing a voltage fluctuation according to a first embodiment. A first wave 104 is shown in solid thick line and a voltage-fluctuated second fluctuating wave 106 is shown in solid thin line.

FIG. 4 shows a waveform of the LED light device 10 experiencing a frequency fluctuation according to a second embodiment. A third wave 108 is shown in solid thick line and a frequency-fluctuated fourth fluctuating wave 110 is shown in solid thin line.

### DETAILED DESCRIPTION

The disclosure will be described with references to the accompanying diagrams.

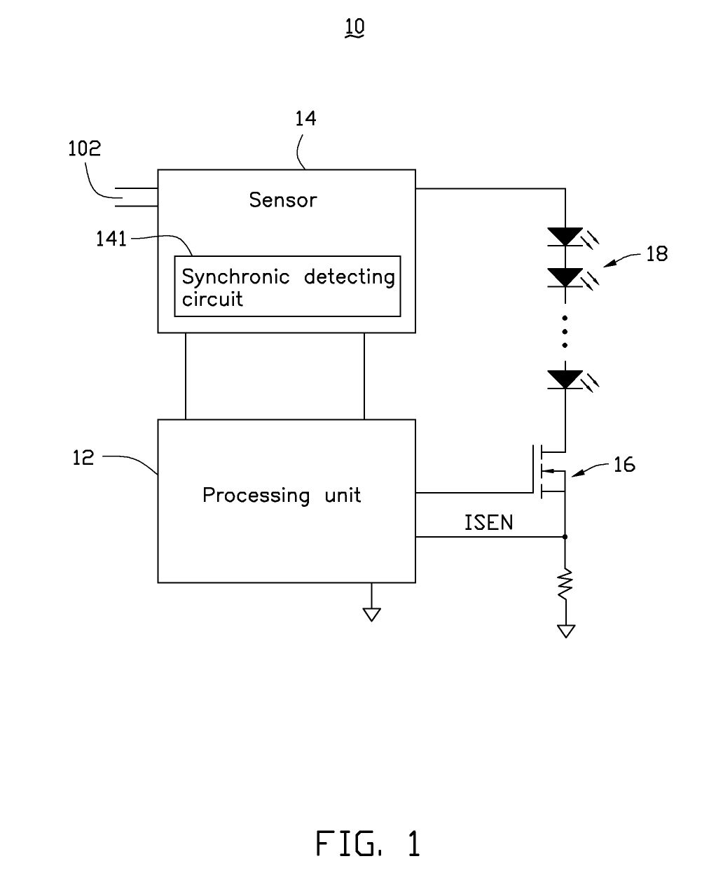

FIG. 1 shows a circuit diagram of an LED light device 10, which includes a processing unit 12, a sensor 14, a MOSFET 16, and an LED 18. The processing unit 12 is electrically connected to the sensor 14 and the MOSFET 16. The sensor 14 is electrically connected to an input power source 102, which provides an alternating current. The LED 18 acts as a light source, and is switched by the MOSFET 16. The sensor 14 has a synchronic detecting circuit 141 which synchronously detects a half cycle time of a half sine wave of the input power source 102. The sensor 14 can determine if the input power source 102 has a voltage fluctuation or a frequency fluctuation, depending on the half cycle time T, and transmits signals related to the voltage fluctuation or the frequency fluctuation of the input power source 102. The processing unit 12 receives signals from the sensor 14 and modulates a duty cycle of the MOSFET 16 accordingly. If the half cycle time is changed, the sensor 14 determines a frequency fluctuation in the input power source. If the half cycle time is constant, the sensor 14 further detects a rise time, wherein the rise time refers to a period of time required for raising the voltage from zero to as threshold voltage (Vₜₕ) of the LED 18. lf the rise time changes, the sensor 14 can determine a voltage fluctuation in the input power source 102.

The processing unit 12 controls the MOSFET 16 to turn on and turn off at a high frequency to provide a constant current for the LED 18, so as to generate a constant luminance. The processing unit 12 controls voltage input to the LED 18. The operation of the MOSFET 16 can he separated into three different modes, depending on the bias at the source, the drain, and the gate terminals of the MOSFET 16. These three different modes are as linear mode, a saturation mode, and a cut-off mode.

When the MOSFET 16 is in the linear mode, the gate-to-source bias (V_{GS}) is greater than the threshold voltage (Vₜₕ) (V_{GS}>Vₜₕ), and a drain-to-source bias (V_{DS}) is lower than the difference between the V_{GS} and the Vₜₕ (V_{DS}<(V_{GS}−Vₜₕ)). The MOSFET 16 is turned on, and a channel is created which allows current to flow between the drain and the source. The MOSFET 16 operates like a resistor, controlled by the gate voltage relative to both the source and drain voltages.

When the MOSFET 16 is in the saturation mode, the V_{GS} is greater than the Vₜₕ(V_{GS}>Vₜₕ), and the V_{DS} is greater than the difference between the V_{GS} and the Vₜₕ (V_{DS}>(V_{GS}−Vₜₕ)). The MOSFET 16 is turned on, and a channel is created, which allows current flow between the drain and source to be provided to the LED 18. The drain current is now weakly dependent upon drain voltage and controlled primarily by the V_{GS}.

When the MOSFET 16 is in the cutoff mode, the V_{GS} is lower than the Vₜₕ (V_{GS}<Vₜₕ). The MOSFET 16 is turned off, and there is no conduction between drain and source.

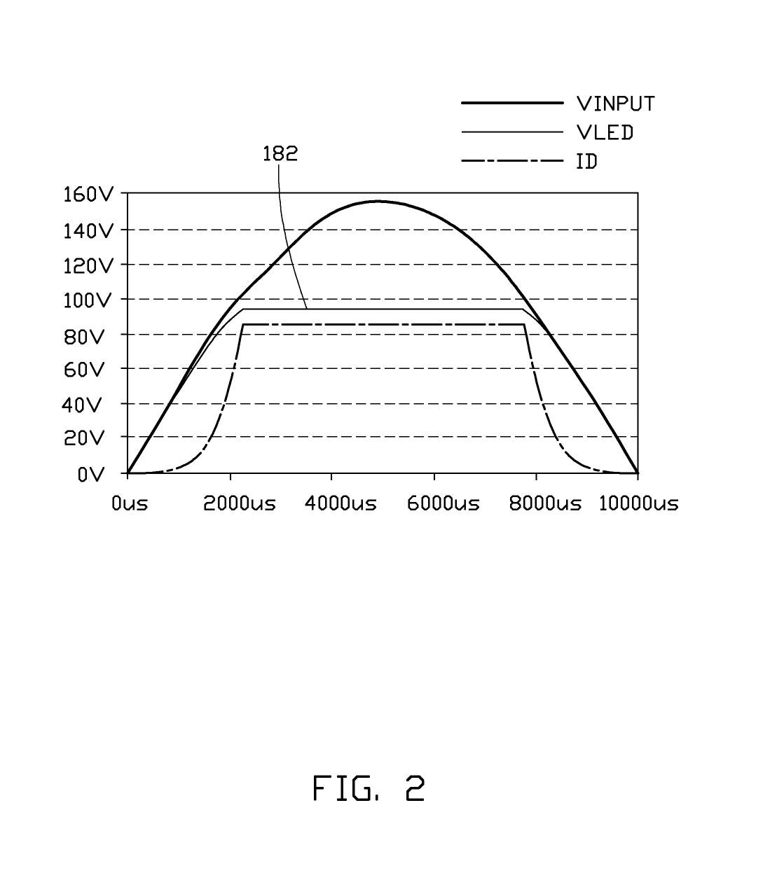

FIG. 2 shows a waveform of an input voltage of the LED lighting device 10, and the MOSFET 16 is in the saturation mode. The X-axis represents time, and the Y-axis represents voltage. The solid thick line represents a half sine wave of the input voltage provided by the input power source 102, VINPUT. The solid thin line represents the voltage of the LED 18, VLED. The dotted line represents the current (ID) flow through the LED 18. During the period of the half sine wave of the input voltage of the MOSFET 16, the voltage of the LED 18 has a horizontal region 182 maintained for a period of time and the current flowing through the LED 18 is constant. The horizontal region 182 occurs when the MOSFET 16 is in the saturation mode to provide constant voltage and constant current for the LED 18. The value of the current is linear to the luminance of the LED 18. When the processing unit 12 modulates the input voltage of the MOSFET 16 at a high level, the luminance of the LED 18 is high. On the other hand, when the processing unit 12 modulates the input voltage of the MOSFET 16 at a low level, the luminance of the LED 18 is low. Therefore, the processing unit 12 acts as a dimmer to modulate the input voltage of the MOSFET 16 and consequently control the luminance of the LED lighting device 10 in several levels.

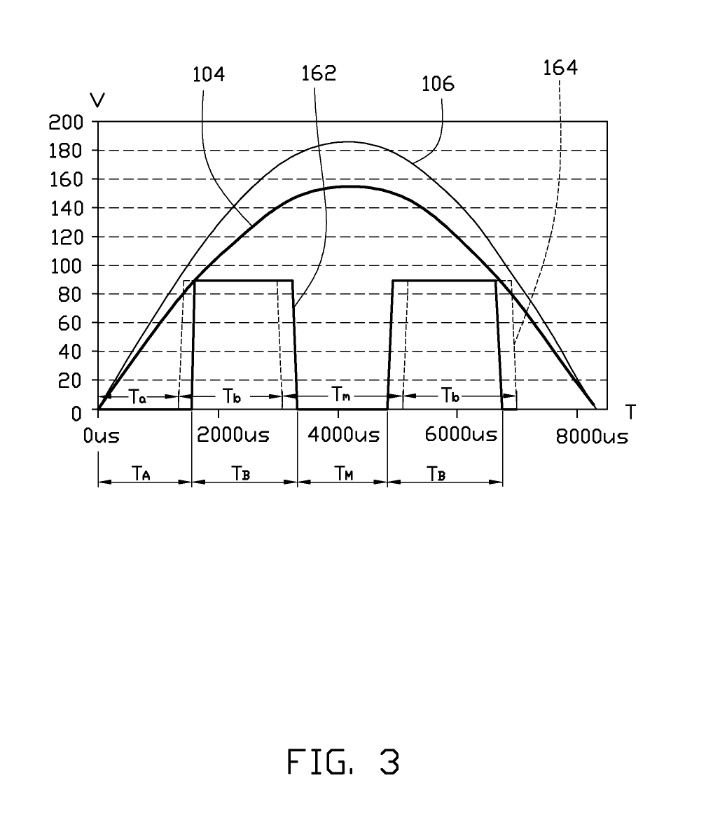

FIG. 3 shows a waveform of the LED light device 10 experiencing a voltage fluctuation according to a first embodiment. The half sine wave of the input voltage of the input power source 102 includes a first wave 104 and a fluctuating second wave 106. As shown in FIG. 3, the peak voltage of the first wave 104 is 110 volt (V), and the peak voltage of the second wave 106 is 132V. The threshold voltage of the MOSFET 16 is 90V. Under the first wave 104, the MOSFET 16 has a first pulse 162, which has a first rise time T_{A}, a first turn-on time T_{B}, a first turn-off time T_{M}, and another first turn-on time T_{B} successive to the first turn-off time T_{M}. The T_{A} refers to the period of time of the first wave 104 rising from 0V to the threshold voltage 90V, the TB refers to the period of time the first wave 104 is maintained at 90V, and T_{M} refers to the period of time of the first wave 104 being maintained at 0V. The first pulse 162 provides a constant current to the LED 18 under the saturation mode of the MOSFET 16. When the first wave 104 is transformed into the second wave 106. a second pulse 164 is formed under the second wave 106 (shown as dotted line in HG 3). The second pulse 164 has a second rise time Tₐ, a second turn-on time T_{b}, second turn-off time Tₘ, and another second turn-on time T_{b} successive to the second turn-off time Tₘ. Comparing the first pulse 162 and the second pulse 164, the T_{A} not equal to the Tₐ. To maintain the current for the LED 18, the first turn-on time T_{B} has to be as long as the second turn-on time T_{b}. Therefore, the T_{M} and the Tₘ should be related and calculable based on the ratio of the T_{A} and the Tₐ, in which the formula is T_{M}=Tₘ×(T_{A}/Tₐ). Accordingly, when the input power source 102 experiences a voltage fluctuation, the processing unit 12 may modulate the MOSFET 16 by changing the duty cycle of the MOSFET 16 to provide constant current for the LED 18. Furthermore, the peak voltage of the second wave 106 is not limited to 132V. The peak voltage of the second wave 106 may be 220V or more.

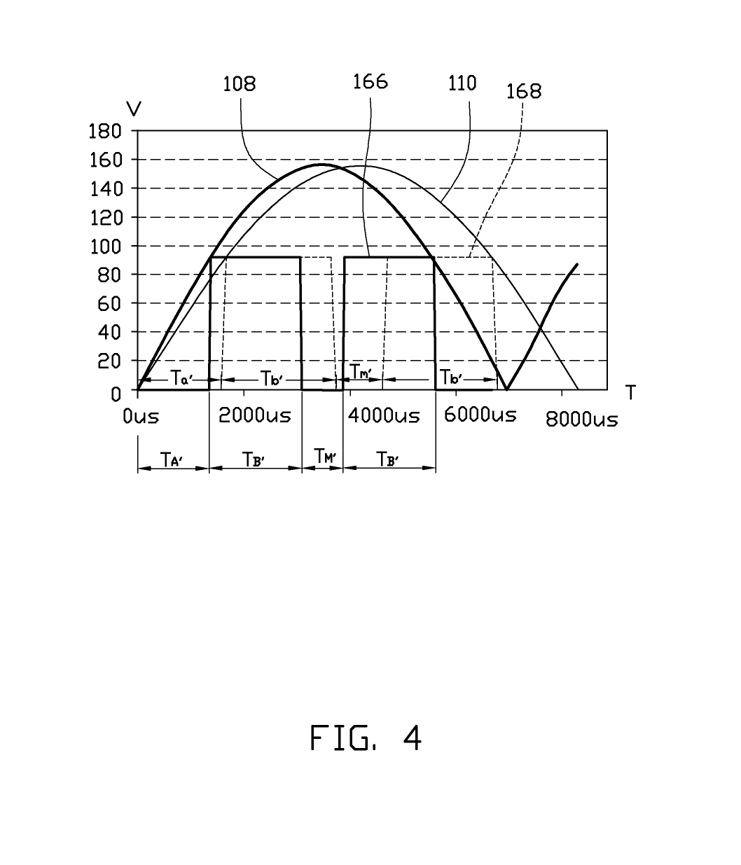

FIG. 4 shows a waveform of the LED light device 10 experiencing a frequency fluctuation according to a second embodiment. The half sine wave of the input voltage of the input power source 102 includes a third wave 106 and a fluctuating fourth wave 110/ As shown in FIG. 4. the peak voltage of the third wave 108 is equal to the Yak voltage of the fourth wave 110 which is 110V. The threshold voltage the MOSFET 16 is 90V. The frequency of the third wave 108 is 60 hertz (Hz), and the frequency of the fourth wave 110 is 50 Hz. Under the third wave 108, the MOSFET 16 has a third pulse 166, which has a third rise time T_{A′}, a third turn-on time T_{B′}, a third turn-off time T_{M′}, and another third turn-on time T_{B′} successive to the third turn-off time T_{M′}. The T_{A}′ refers to the period of time of the third wave 108 rising from 0V to the threshold voltage 90V, the T refers to the period of time the third wave 108 being maintained at 90V, and the T_{M′} refers to the period of time of the third 108 being maintained at 0V. The third pulse 166 provides a constant current to the LED 18 under the saturation mode of the MOSFET 16. When the third wave 108 changes to the fourth wave 110, a fourth pulse 168 is formed under the fourth wave 110 (shown as dotted line in FIG. 4). The fourth pulse 164 has a fourth rise time T_{a′}, a fourth turn-on time T_{b′}, a fourth turn-off time T_{m′}, and another fourth turn-on time T_{b′} successive to the fourth turn-off time T_{m′}.

Comparing the third pulse 166 and the fourth pulse 168, the T_{A′} is not equal to the T_{a′}. To maintain the current for the LED 18, the T_{B′} is proportional to the T_{b′}. The formula for the T_{B′} and the FT_{b′} is T_{B′}=T_{b′}×(T_{A′}/T_{a′}). In addition, the T_{M′} and the T_{m′} should be related and calculable based on the ratio of the T_{A′} and the T_{a′}. The formula is T_{M′}=t_{m′}×(T_{A′}/T_{a′}). When the input power source 102 has a frequency fluctuation, the processing unit 12 may modulate the MOSFET 16 by changing the duty cycle of the MOSFET 16 to provide constant current for the LED 18.

As described above, the sensor 14 detects voltage and frequency fluctuations of the input power source 102. The processing unit 12 modulates the duty cycle of the MOSFET 16 according to the signal from the sensor 14 to reduce energy consumption caused by potential differences and improves the efficiency of luminance of the LED lighting device 10.

Although the present disclosure has been specifically described on the basis of this exemplary embodiment, the disclosure is not to be construed as being limited thereto. Various changes or modifications may be made to the embodiment without departing from the scope and spirit of the disclosure.

What is claimed is:

1. An LED lighting device, comprising:
an LED, acting as a light source;
a MOSFET electrically connected to the LED;
a sensor electrically connected to the MOSFET and detecting an input power source of the LED lighting device; and
a process unit electrically connected to the sensor, the process unit controlling the MOSFET;
wherein if the sensor detects a voltage fluctuation or a frequency fluctuation of the input power source, the process unit modulates a duty cycle of the MOSFET to maintain a constant output current for the LED.

2. The LED light device of claim 1, wherein the sensor has a synchronic detecting circuit to monitor a half cycle time of a half-cycle sine wave of the input power source.

3. The LED light device of claim 2, wherein if the half cycle time of the half-cycle sine wave is changed, the sensor determines the input power source has a frequency fluctuation.

4. The LED light device of claim 2, wherein if the half cycle time of the half-cycle sine wave is constant, the sensor detects a rise time of the half-cycle sine wave.

5. The LED light device of claim 4, wherein if the rise time of the half-cycle sine wave is changed, the sensor determines the input power source has a voltage fluctuation.

6. The LED light device of claim 1, wherein the process unit modulates the MOSFET when the MOSFET is in a saturation mode.

7. The LED light device of claim 6, wherein the process unit modulates the frequency of the pulse.

8. The LED light device of claim 6, wherein the LED has an input voltage maintaining in a horizontal region for a period of time.

9. The LED light device of claim 6, wherein the input power source provides:
a first wave, the first wave having a first peak voltage, a first rise time T_{A}, a first turn-on time T_{B}, and a first turn-off time T_{M}; and
a second wave, the second wave having a second peak voltage, a second rise time Tₐ, a second turn-on time T_{b}, and a second turn-off time Tₘ;
wherein the first peak voltage is not equal to the second peak voltage that the input power source has a voltage fluctuation.

10. The LED light device of claim 9, wherein the TA is not equal to the Ta, and the Tm is modulated according to a formula, T_{M}=Tₘ×(T_{A}/Tₐ).

11. The LED light device of claim 6, wherein the input power source provides:
a third wave, the first wave having a third frequency, a third rise time T_{A′}; a third turn-on time T_{B′}, and a third turn-off time T_{M′}; and
a fourth wave, the fourth wave having a fourth peak voltage, a fourth rise time T_{a′}, a fourth turn-on time T_{b′}, and a fourth turn-off time T_{m′};
wherein the third frequency is not equal to the fourth frequency that the input power source has a frequency fluctuation.

12. The LED light device of claim 11, wherein the Tm′ is modulated according to a formula, T_{M′}=T_{m′}×(T_{A′}/T_{a′}).

13. The LED light device of claim 11, wherein the process unit modulates a turn-on time of the pulse of the pulse.

14. The LED light device of claim 13, wherein the Tb′ is modulated according to a formula, T_{B′}=T_{b′}×(T_{A′}/T_{a′}).
